(19) United States
(12) Patent Application Publication
(10) Pub. No.: US 2008/0098025 A1
(43) Pub. Date: Apr. 24, 2008

(54) Electronic catalog

(75) Inventors: Viswanath Vadlamani, Sammamish, WA (US); Derek Lynn Jamison, Bellevue, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/583,465

(22) Filed: Oct. 18, 2006

(51) Int. Cl. G06F 7/00

(52) U.S. Cl. 707/102

(57) ABSTRACT

An electronic catalog may have one or more associated attributes describing one or more features of included items. A processing device may display a group of nodes, each of which may represent a different attribute with respect to the included items. A user may select one of the nodes causing the displayed nodes to be pivoted. The selected node may be displayed as a root node while the remaining nodes may be displayed as descendent nodes. Each of the descendent nodes may represent one or more of the included items having the attribute of the root node and the attribute of the respective descendent node. The user may pin one of the descendent nodes to cause one or more new nodes to be displayed as descendent nodes of the pinned node. The processing device may create an offline electronic catalog from a selected portion of the electronic catalog.

### BACKGROUND

Typically, when searching an online database such as, for example, an electronic catalog of products, one may browse the various categories of products by traversing a hierarchy of categories. For example, suppose one is interested in an item which may be found in an office products category. Within the office products category a number of sub-categories may be presented such as, for example, electronic products, calendars, desk clocks, etc. A number of products may be included under the electronic products category such as, for example, paper shredders, scanners, printers, etc.

If an item one is searching for within the electronic catalog is not one that easily fits a predefined category, searching a predefined hierarchy of categories may be inefficient. Further, when network access is not available for one reason or another, one will not have access to the online database

### SUMMARY

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

In embodiments consistent with the subject matter of this disclosure, items within an electronic catalog may have one or more associated attributes. The attributes may describe one or more features of the item. A user of a processing device may request a display of nodes, each of which may represent a different attribute with respect to the items in the electronic catalog. The user may select one of the nodes and, as a result of the selection, the displayed nodes may be pivoted. The selected node may be displayed as a root node while the remaining nodes may be displayed as descendent nodes, or children, of the root node. Further, each of the descendent nodes may represent one or more items in the database having the attribute of the root node and the attribute of the respective descendent node.

The user may further select or pin one of the descendent nodes to cause one or more new nodes to be displayed as descendent nodes of the pinned node. The one or more descendent nodes may each represent one or more items in the electronic catalog that have the attributes of the pinned node and an additional respective attribute.

The electronic catalog may include copies of digital products for downloading. Examples of the digital products may include music, videos, games, and software applications, as well as other digital products. Further, the electronic catalog may include an activation code with respect to at least some of the digital products. For example, a user may purchase and download a digital product from the electronic catalog and may receive an activation code for activating the digital product. After installation of the digital product on a user's processing device, the user may enter a respective activation code to activate the features of the installed digital product.

When a user is satisfied with the display of nodes, the user may select a subset of the displayed nodes for an offline electronic catalog. A processing device having access to the electronic catalog may then create the offline electronic catalog, and may copy the offline electronic catalog to a portable device. In some embodiments, the portable device may be a handheld processing device, or other portable processing device. In other embodiments, the portable device may be a portable storage device such as, for example, a U3 device or other portable storage device, which may be connected to a portable processing device at a later time. Other examples of portable storage devices may include compact disc (CD), digital video disc (DVD), and flash RAM, as well as other storage media.

The aforementioned examples are not intended to be limiting in any manner, but instead are intended to merely illustrate exemplary embodiments by which the subject matter of this disclosure may be implemented.

### DRAWINGS

In order to describe the manner in which the above-recited and other advantages and features can be obtained, a more particular description is described below and will be rendered by reference to specific embodiments thereof which are illustrated in the appended drawings. Understanding that these drawings depict only typical embodiments and are not therefore to be considered to be limiting of its scope, implementations will be described and explained with additional specificity and detail through the use of the accompanying drawings.

FIG. 1 illustrates an exemplary operating environment consistent with the subject matter of this disclosure.

FIG. 2 is a functional block diagram illustrating an exemplary processing device, which may be used in implementations consistent with the subject matter of this disclosure.

FIGS. 3A-3E illustrate exemplary display screens, which may be displayed in embodiments consistent with the subject matter of this disclosure.

FIG. 4 shows a flowchart of an exemplary process, which may be performed in the various embodiments.

FIG. 5 illustrates an exemplary derived attribute rule definition consistent with the subject matter of this disclosure.

FIGS. 6 and 7 show flowcharts of exemplary processes, which may be performed in embodiments consistent with the subject matter of this disclosure.

### DETAILED DESCRIPTION

Embodiments are discussed in detail below. While specific implementations are discussed, it should be understood that this is done for illustration purposes only. A person skilled in the relevant art will recognize that other components and configurations may be used without parting from the spirit and scope of the subject matter of this disclosure.

### Exemplary Operating Environment

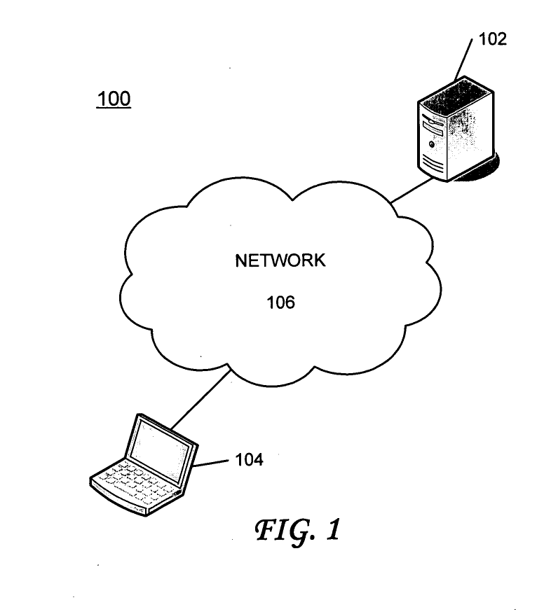

FIG. 1 illustrates an exemplary operating environment 100 for an embodiment consistent with subject matter of this disclosure. Operating environment 100 may include a processing device 102, a processing device 104 and a network 106.

Processing device 102 may be, for example, a server or other processing device capable of executing a database system. Processing device 104 may be a personal computer (PC), a handheld processing device, or other processing device capable of executing applications and communicating with processing device 102 via network 106.

Network 106 may be a wired or wireless network and may include a number of devices connected via wired or wireless means. Network 104 may include only one network or a number of different networks, some of which may be networks of different types. Network 106 may include a packet-switching network, a wireless network, an ATM network, a Frame Relay network, an optical network, a Public Switched Telephone Network (PSTN), a satellite network, the Internet, or an intranet or other types of networks, or any combination of the above networks.

In operating environment 100, processing device 104 may execute an application which accesses information in a database of processing device 102 via network 106. In an embodiment consistent with the subject matter of this disclosure, the database may include an electronic catalog of products. Some of the products may include digital products such as, for example, music, videos, games, software applications, or other digital products.

FIG. 1 illustrates an exemplary operating environment. Other operating environments or variations of operating environment 100 may be used with other embodiments consistent with the subject matter of this disclosure. For example, in one embodiment, functions or services performed by processing device 102 may be distributed across multiple processing devices which may be connected via a network, such as, for example, network 106.

### Exemplary Processing Device

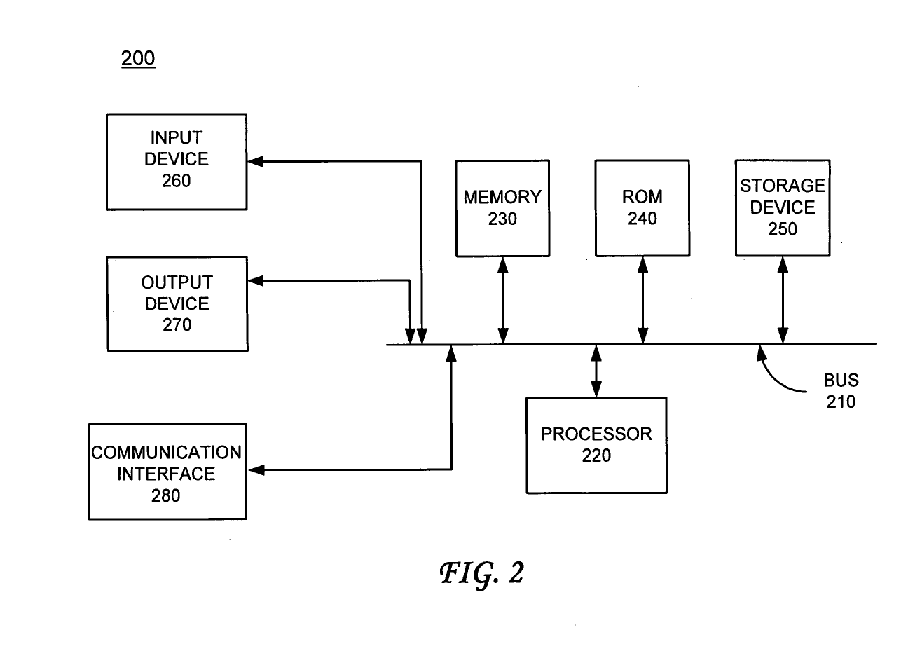

FIG. 2 is a functional block diagram that illustrates an exemplary processing device 200, which may be used to implement processing device 102, processing device 104, or both devices. Processing device 200 may include a bus 210, a processor 220, a memory 230, a read only memory (ROM) 240, a storage device 250, an input device 260, an output device 270, and a communication interface 280. Bus 210 may permit communication among components of processing device 200.

Processor 220 may include at least one conventional processor or microprocessor that interprets and executes instructions. Memory 230 may be a random access memory (RAM) or another type of dynamic storage device that stores information and instructions for execution by processor 220. Memory 230 may also store temporary variables or other intermediate information used during execution of instructions by processor 220. ROM 240 may include a conventional ROM device or another type of static storage device that stores static information and instructions for processor 220. Storage device 250 may include any type of media for storing data and/or instructions. When processing device 200 is used to implement processing device 102, storage device 250 may include one or more databases of a database system.

Input device 260 may include one or more conventional mechanisms that permit a user to input information to processing device 200, such as, for example, a keyboard, a mouse, or other input device. Output device 270 may include one or more conventional mechanisms that output information to the user, including a display, a printer, or other output device. Communication interface 280 may include any transceiver-like mechanism that enables processing device 200 to communicate with other devices or networks. In one embodiment, communication interface 280 may include an interface to network 106.

Processing device 200 may perform such functions in response to processor 220 executing sequences of instructions contained in a machine-readable medium, such as, for example, memory 230, or other medium. Such instructions may be read into memory 230 from another machine-readable medium, such as storage device 250, or from a separate device via communication interface 280.

### Overview

In a typical database such as, for example, an electronic catalog, products included in the database may be assigned to different categories and the categories may be assigned a position in a hierarchical structure. Thus, a user browsing the database may start by browsing a hierarchy of predefined categories and may subsequently browse other categories of interest at a lower level in the hierarchy. However, a user may have difficulty finding an item which does not fit well into the predefined structure of hierarchical categories.

In embodiments consistent with the subject matter of this disclosure, items within a database such as, for example, an electronic catalog, may have one or more associated attributes. The attributes may describe one or more features of the item. For example, digital items stored in an electronic catalog may include attributes such as, for example: “works with XYZ operating system or later”, “requires at least 512 MB of memory”, “educational product”, “for ages 5-9”, etc.

A user of a processing device such as, for example, processing device 104, may request a display of nodes. Each of the displayed nodes may represent a different attribute with respect to the items in a database such as, for example, an electronic catalog. The user may select one of the nodes and, as a result of the selection, the displayed nodes may be pivoted. The selected node may be displayed as a root node while the remaining nodes may be displayed as descendent nodes, or children, of the root node. Further, each of the descendent nodes may represent one or more items in the database having the attribute of the root node and the attribute of the respective descendent node.

The user may further select or pin one of the descendent nodes. Pinning a descendent node may cause one or more new nodes to be displayed as descendent nodes of the pinned node. The one or more descendent nodes may each represent one or more items in the database that have the attributes of the pinned node and an additional respective attribute.

Each item of the database may have one or more attributes associated therewith. Some attributes may be inherent such as, for example, “educational software”, and “requires more than 512 MB of memory”, as well as other attributes. Other attributes may be derived or calculated such as, for example, “works on laptop”, “works with XYZ series of games”, or other attributes. Whether an item in the database has a particular derived attribute may be determined by applying a rule. In some embodiments, a user may be permitted to define a rule with respect to a derived or calculated attribute. This will be discussed in more detail below.

In embodiments in which the database is an electronic catalog, the electronic catalog may include copies of digital products for downloading. Examples of the digital products may include music, videos, games, and software applications, as well as other digital products. Further, the electronic catalog may include an activation code with respect to at least some of the digital products. For example, a user may purchase and download a digital product from the electronic catalog and may receive an activation code for activating the digital product. After installation of a digital product on a user's processing device, the user may enter a respective activation code to activate the features of the installed digital product.

When a user is satisfied with the display of nodes, the user may select a subset of the displayed nodes for an offline database or electronic catalog. A processing device such as, for example, processing device 102, may then create the offline database such as, for example, the offline electronic catalog, and may copy the offline database to a portable device. In some embodiments, the portable device may be a handheld processing device. In other embodiments, the portable device may be a portable storage device such as, for example, a U3 device or other portable storage device, which may be connected to a portable processing device at a later time. Other examples of portable storage devices may include CD, DVD, and flash RAM, as well as other storage media.

In embodiments in which the database is an offline electronic catalog and the offline electronic catalog is accessible by a portable processing device such as, for example, a handheld processing device, the portable processing device may display a group of nodes, wherein each of the nodes represents a different attribute with respect to one or more items in the offline electronic catalog. A user of the portable device may select one of the displayed nodes, resulting in the pivoting of the displayed nodes, as described above with respect to the online electronic database. Further, selecting or pinning one of the displayed descendent nodes may result in new descendent nodes of the pinned node being displayed, as previously described with respect to the online electronic database. The user may then select one of the displayed nodes to cause a listing of products having the attributes associated with the selected node.

A user having a portable processing device with an offline database such as, for example, an offline electronic catalog, may use the offline database to permit a viewer to view information about products of interest included in the offline database. If the viewer is interested in a digital product included in the offline database, the user may copy the digital product to a portable processing device of the viewer via a wired or wireless connection or the user may copy the digital product to a portable storage device such as, for example, a U3 device, a flash RAM device, a CD, a DVD, or other portable storage medium. Further, instead of downloading the digital product from the offline database for the viewer who is interested in having a copy of the digital product, the user may have prepackaged portable storage media including a number of digital products described in the offline database. In such a case, the user may simply hand one of the prepackaged portable storage media having the digital product of interest to the viewer who is interested in the digital product.

If the digital product is one which requires an activation code to activate features of the digital product after being installed on a processing device the user may have a number of activation codes for a variety of digital products and may simply provide an appropriate activation code to the viewer. Alternatively, the user may send a request for an activation code to a processing device, such as a server which may include activation codes for a number of digital products. The request may be sent wirelessly or via wired means through a network such as, for example, network 106 or another network. In one embodiment consistent with the subject matter of this disclosure, the user may send the request for the activation code from his or her processing device using Short Message Service (SMS). In one implementation, an SMS message may be sent via a satellite network. Upon receipt of the request for an activation code, the server or other processing device may respond with a message including the activation code. In an implementation in which the request for the activation code is sent via a SMS message, the server or other processing device responding to the request may respond via another SMS message. The user's processing device may receive the response and display the activation code to the user, who may then provide the code to the viewer.

### Exemplary Display Screens

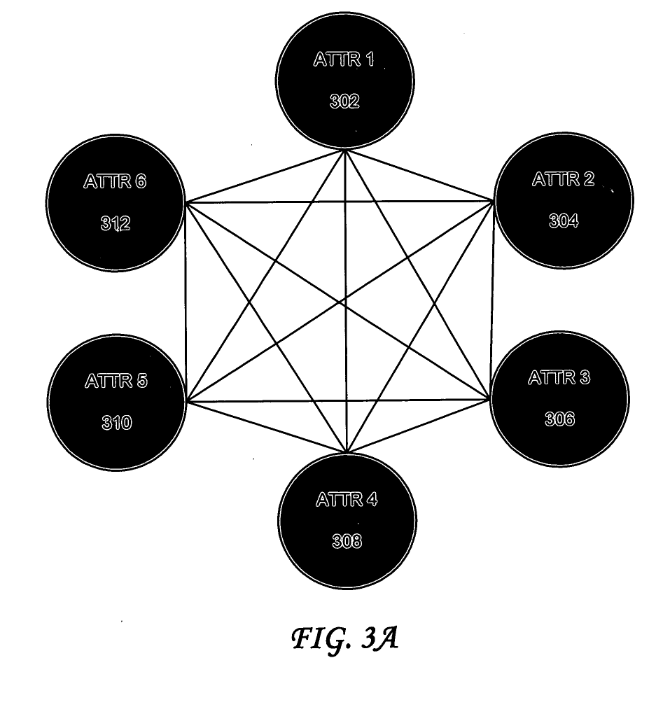

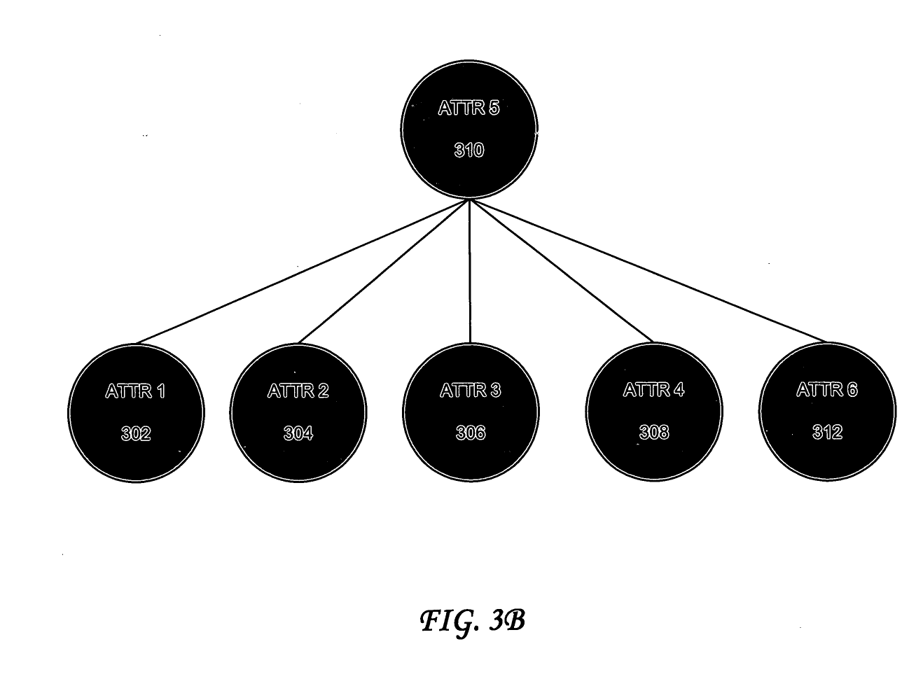

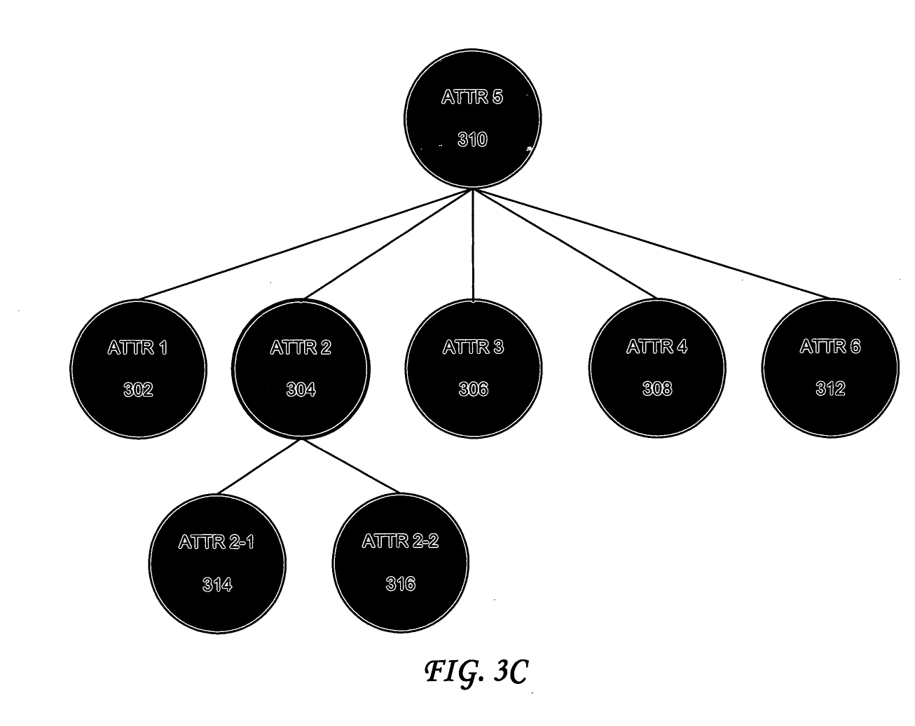

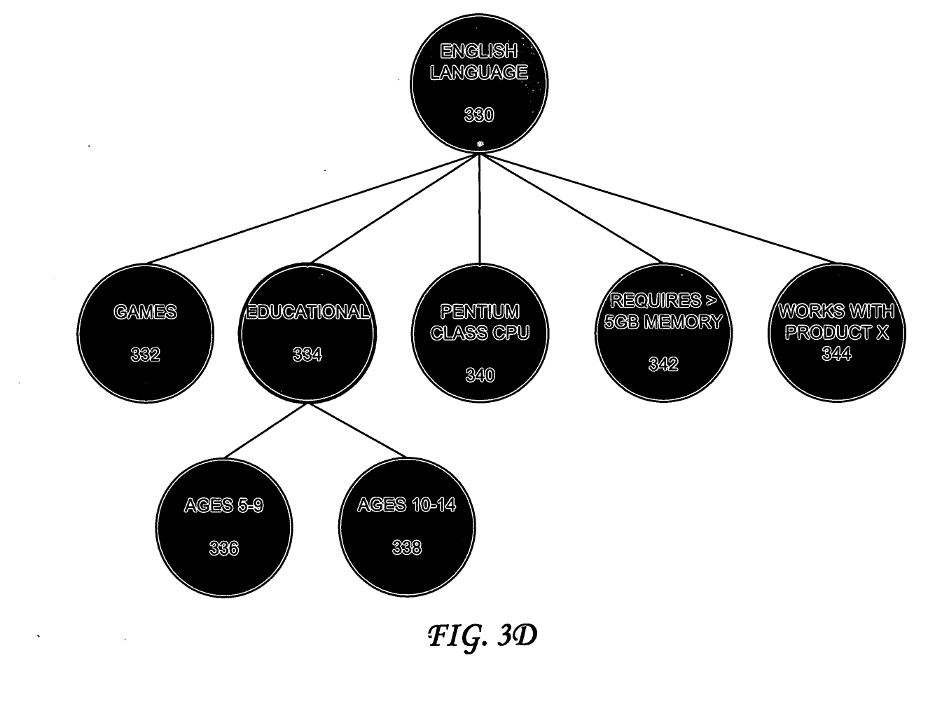

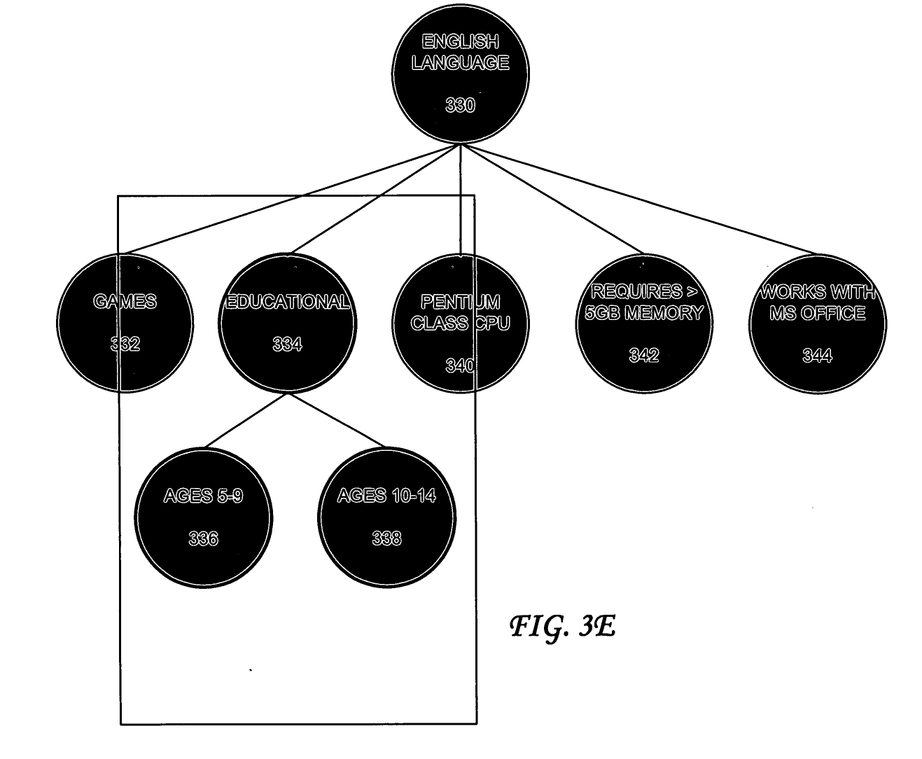

When a user accesses the online database or electronic catalog via a processing device, the user may be presented with a display of a group of nodes, as illustrated by an exemplary display of FIG. 3A. FIG. 3A shows an exemplary display of a group of nodes, nodes 302-312, consistent with the subject matter of this disclosure. Each of nodes 302-312 may represent a different attribute of the one or more products included in a database such as, for example, an electronic catalog. In one implementation, at least some of the products may be digital products such as, for example, music, videos, games, software applications, or other digital products.

Each of the attributes may be an inherent attribute or a derived or calculated attribute. Examples of inherent attributes may include “requires at least a Pentium class processor or equivalent”, and “works only with XYZ operating system or later”, or other inherent attributes. A derived or calculated attribute is determined according to a rule. Examples of derived or calculated attributes may include “works on laptop”, “is compatible with XYZ products”, as well as other derived or calculated attributes.

In the exemplary display of FIG. 3A, each of the displayed nodes is connected to each other of the displayed nodes via a line. In other embodiments, the displayed nodes may not be connected to one another. As shown in FIG. 3A, node 302 may represent at least one product having attribute 1, node 304 may represent at least one product having attribute 2, node 306 may represent at least one product having attribute 3, nodes 308 may represent at least one product having attribute 4, node 310 may represent at least one product having attribute 5, and node 312 may represent at least one product having attribute 6.

A user may select any one of nodes 302-312 to cause a new display to be presented, as illustrated in an exemplary display illustrated in FIG. 3B. The exemplary display of FIG. 3B illustrates a pivoted display of the nodes of FIG. 3A after the user selected, for example, node 310 for pivoting. The user may make a selection of one of the nodes of an exemplary display such as, for example, the display of FIG. 3A, by using a pointing device such as, for example, a computer mouse, an electronic pen or stylus, a user's finger on a touch screen display, or other input means. The pivoted display of FIG. 3B shows the selected node, node 310, being displayed in a root node position of the display and the remaining nodes, nodes 302, 304, 306, 308 and 312, being displayed as descendent or child nodes of node 310. Lines may be displayed connecting the root node, nodes 310, to each of the descendent nodes. As mentioned previously, node 310 may represent at least one product in the database or electronic catalog having attribute 5. However, each of nodes 302, 304, 306, 308 and 312 represents at least one product having attribute 5 and the attribute associated with each of the respective nodes 302, 304, 306, 308 and 312.

A user may select one of the displayed descendent nodes of FIG. 3A in order to see a display of at least one new node representing at least one product having the attribute of the selected node and an additional attribute. Such a selection may be called pinning the displayed descendent node. The user may pin one of the descendent nodes in the same manner as selecting a node for pivoting, with respect to FIG. 3A, or via another method. FIG. 3C illustrates an exemplary display in response to a user selecting node 304 of FIG. 3B.

As shown in the exemplary display of FIG. 3C, two additional descendent nodes, nodes 314 and 316, are shown with respect to the selected or pinned node, node 304. The pinned node, 304 is shown as a parent node to descendent nodes 314 and 316. Nodes 314 and 316 may be connected to parent node 304 by respective lines. Node 314 represents at least one product having attribute 5, attribute 2 and attribute 2-1. Node 316 represents at least one product having attribute 5, attribute 2 and attribute 2-2.

The display shown in FIG. 3C is an exemplary display. More or fewer nodes may be displayed in an actual embodiment consistent with the subject matter of this disclosure. For example, only one descendent node of node 304 may be displayed in one embodiment, while in another embodiment a number of nodes may be displayed as descendent nodes of node 304.

FIG. 3D illustrates a exemplary displayed group of nodes, nodes 330, 332, 334, 340, 342 and 344, after a user selected node 330 as a pivot node. In this exemplary display, each of the nodes has one or more particular attributes. For example, node 330 represents at least one product having an attribute indicating that the product is for those who understand the English language. Node 332 represents at least one product having attributes indicating that the product is for those who understand the English language and that the at least one product is associated with games. Node 334 represents at least one product having attributes indicating that the at least one product is for those who understand the English language and is an educational product. Node 340 represents at least one product having attributes indicating that the at least one product is for those who understand the English language must be executed in a processing device having a Pentium class central processing unit (CPU). Node 342 represents at least one product having attributes indicating that the at least one product is for those who understand the English language and must be executed on a processing device having at least 5 GB of memory. Node 344 represents at least one product having attributes indicating that the at least one product is for those who understand the English language and that the at least one product works with another product called product X.

The exemplary display shown in FIG. 3D shows an exemplary result after the user selected or pinned node 334, representing at least one product having attributes indicating that the product is for those who understand the English language and is for educational use. In the exemplary display two descendent nodes, nodes 336 and 338 may be displayed with respect to parent node 334. Node 336 may represent at least one product that has attributes indicating that the product is for English-language speakers, is educational and is for users between the ages of 5 and 9. Node 338 may represent at least one product that has attributes indicating that the product is for English-language speakers, is educational and is for users between the ages of 10 and 14. The user may select any of the nodes of FIG. 3D to see a displayed listing of the one or more products having the one or more attributes associated with the selected node.

The display shown in FIG. 3D is an exemplary display. More or fewer nodes may be displayed in an actual embodiment consistent with the subject matter of this disclosure. For example, only one descendent node of node 334 may be displayed in one embodiment, while in another embodiment a number of nodes may be displayed as descendent nodes of node 334.

In some embodiments consistent with the subject matter of this disclosure, the user may continue the pinning process by pinning any of the nodes that are leaf nodes, which may result in one or more descendent nodes of the pinned node being displayed.

In embodiments consistent with the subject matter of this disclosure, a user may select a subset of the displayed nodes and may request the creation and download of an offline database such as, for example, an offline electronic catalog, including information about products represented by the selected subset of the displayed nodes. The offline electronic catalog may include downloadable files with respect to at least one digital product and may include activation keys associated with at least some of the at least one digital product.

FIG. 3E illustrates the displayed nodes of FIG. 3D having an area showing a subset of the displayed nodes selected by a user. The user may select a subset of displayed nodes by clicking and dragging an input device such as, for example, a computer mouse, or other input device over the subset of the displayed nodes. In one embodiment, only those nodes that are completely within a selected area are included in the selected subset for the offline electronic catalog. The exemplary display of FIG. 3E illustrates a selected subset including nodes 334, 336, and 338. In some embodiments, the displayed nodes in the selected subset may have a visual indication confirming the selection. In one embodiment, the visual indication may be a heavy line surrounding each node, nodes being displayed in a particular color, blinking nodes, or other methods. The selected nodes shown in FIG. 3E have a visual indication that includes a heavy line surrounding each of the selected nodes.

The electronic catalog may be downloaded to a portable processing device or to a portable storage device such as, a U3 device, a flash RAM device, a CD, a DVD, or other portable storage device. If the electronic catalog is downloaded to a portable storage device, the portable storage device may later be connected to a portable processing device such as, for example, a handheld processing device, such that a user may browse the offline electronic catalog by using the portable processing device.

In some embodiments, the portable processing device having access to the offline electronic catalog may include displays such as, for example, those illustrated in FIGS. 3A-3D, thereby permitting a user to display a group of nodes, select a pivot node and pin nodes.

### Exemplary Methods

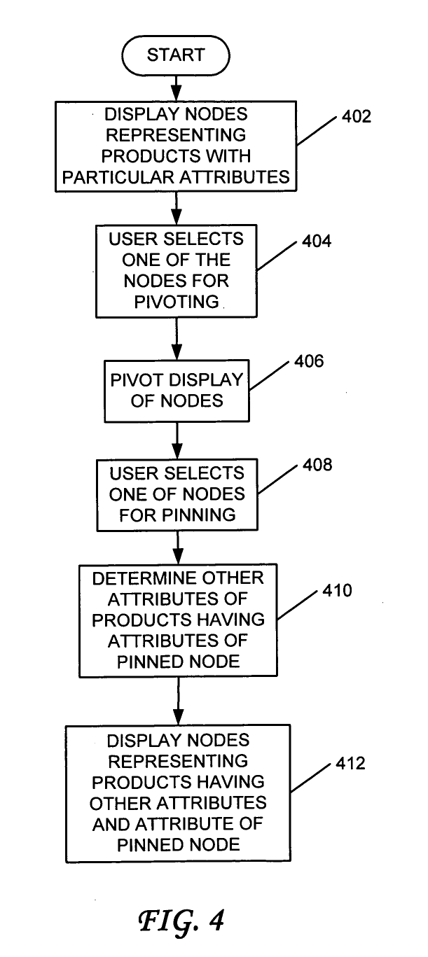

FIG. 4 is a flowchart that illustrates an exemplary process which may be performed in embodiments consistent with the subject matter of this disclosure. The exemplary process of FIG. 4 illustrates the display of nodes representing products, the pivoting of nodes, and pinning of nodes.

The process may begin with a user of a processing device such as, for example, processing device 104, requesting accessing to a database such as, for example, an electronic catalog, on a remote processing device such as, for example processing device 102. In response to the request for access to the database, processing device 102 may provide information to processing device 104, such that processing device 104 displays a group of nodes, each of which may represent at least one product with a particular respective attribute (act 402). The user may select one of the displayed nodes for pivoting, as described with respect to FIGS. 3A and 3B and processing device 102 may send information to processing device 102 information indicating the user's selection (act 404). The user may select one of the displayed nodes by a number of different means, including using a pointing device such as, for example, a computer mouse, and clicking on one of the displayed nodes (act 404). In other implementations, other methods may be used to select one of the displayed nodes.

Processing device 104 may receive the user's selection and may pass information indicating the user's selection to processing device 102 via a network such as, for example network 106. Upon receiving the information including the user's selection, processing device 102 may send information to processing device 104 via network 106, such that a display of pivoted nodes is shown on a display screen of processing device 104 (act 406). The display of pivoted nodes may be as described with reference to FIG. 3B. That is, the node selected for pivoting may be displayed as a root node and the remaining nodes may be displayed as descendent nodes of the selected node.

Next, the user may select one of the descendent nodes for pinning via processing device 104 (act 408). Information describing which of the displayed nodes is selected for pinning may be sent to processing device 102 via network 106. Processing device 102 may then determine whether any products of the electronic catalog include attributes of the pinned node, as well as other attributes (act 410). If processing device 102 determines that at least one product of the electronic catalog includes attributes of the pinned node and at least one other attribute, then processing device 102 may provide display information to processing device 104, via network 106, such that processing device 104 may display one or more descendent nodes of the pinned node. Each of the one or more descendent nodes of the pinned node may represent at least one product having attributes of the pinned node and one other respective attribute, as described previously with respect to FIG. 3C (act 412).

The process illustrated by the flowchart of the FIG. 4 is an exemplary process. Variations of the process may be implemented in other embodiments consistent with the subject matter of this disclosure. For example, in some embodiments, a user may select any displayed leaf node for pinning.

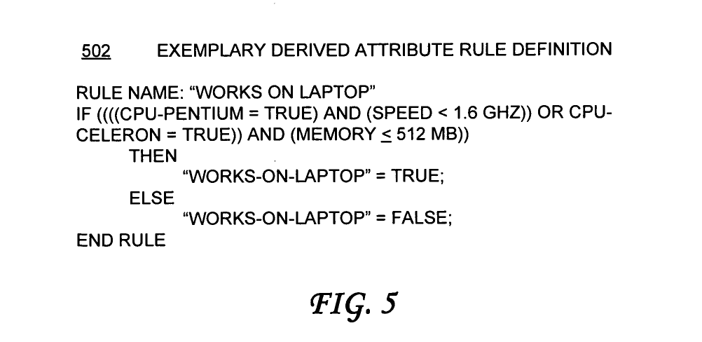

In some embodiments consistent with the subject matter of this disclosure, a user may define a rule for a derived or calculated attribute. FIG. 5 illustrates exemplary rule 502, which describes an exemplary rule named “works on laptop”. The user may define the rule by requesting access to a rule editor and entering definition statements, such as those shown in FIG. 5, via a processing device such as, for example, processing device 104 communicating, via network 106, with processing device 102, which may be executing the rule editor. In an alternate embodiment, the rule editor may be executing on processing device 104, and upon completion of defining the rule using processing device 104, information including the completed rule may be sent to processing device 102 via network 106.

As shown in FIG. 5, exemplary rule 502 may include a rule name statement which may define the name of the rule. As shown in FIG. 5, the name of this exemplary rule is “works on laptop”. Of course, other methods for defining a name for a rule may be employed. A rule definition may include a conditional statement for checking a condition of other attributes. For example, exemplary rule 502 includes a conditional statement which checks whether a product of the electronic catalog has an attribute called “CPU-PENTIUM” set to TRUE and an attribute called “SPEED” with a value less than 1.6 GHZ, or whether the product includes an attribute called “CPU-CELERON”, and whether the product includes an attribute called “MEMORY” with a value less than or equal to 512 MB. If the condition in the conditional statement is satisfied, then the derived attribute “WORKS-ON-LAPTOP” may be set to TRUE. Otherwise, the derived attribute “WORKS-ON-LAPTOP” may be sent to FALSE.

Rule 502 of FIG. 5 is an exemplary rule. Other rules may be defined in other embodiments consistent with the subject matter of this disclosure. For example, a rule in another embodiment may have a different name, or may have one or more conditional statements checking existence of other conditions based on other attributes. Further, rule 502 illustrates a statement defining a rule occurring at a beginning of a rule. However, such a statement may occur at any point in the rule definition including, for example, in a middle or end of a rule definition, or not appearing in the rule definition at all.

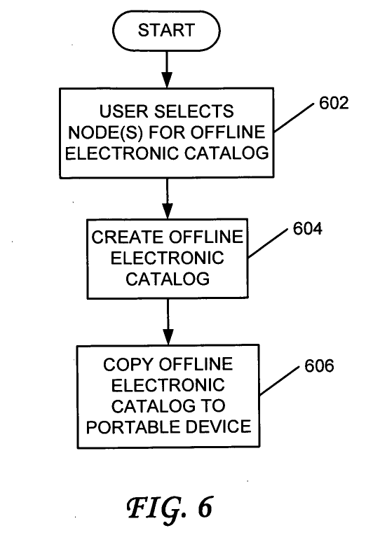

FIG. 6 is a flowchart of an exemplary process that may be performed in embodiments consistent with the subject matter of this disclosure. The exemplary process of FIG. 6 illustrates a process by which a user may select a subset of displayed nodes for an offline electronic catalog. The process may begin with the user selecting a subset of the displayed nodes from a display, such as previously described with respect to, for example, FIGS. 3C-3E (act 602). In one embodiment, the user may view displayed nodes on a display screen of a processing device such as, for example, processing device 104, and may select the subset of the displayed nodes by a number of different input means including the use of a pointing device such as, for example, a computer mouse, by which the user may click and drag the pointing device over an area of the display screen thereby creating an area around the selected subset of displayed nodes.

Information regarding the selected subset of displayed nodes may be transmitted from processing device 104 to another processing device having the electronic catalog such as, for example, processing device 102, via a network such as, for example, network 106. Processing device 104 may receive the information regarding the selected subset of displayed nodes and may create an offline electronic catalog including information about products represented by the selected subset of the displayed nodes (act 604). Processing device 102 may then download the offline electronic catalog to processing device 104, which may be a portable device (act 606). Processing device 104 may store the electronic catalog on a storage medium such as, for example, a hard disk drive. Alternatively, processing device 104 may store the electronic catalog on a portable storage medium such as, for example, a U3 device, a flash RAM device, a CD, a DVD, or other portable storage medium, which may later be used with a processing device such as, for example, a portable processing device, for showing information from the offline electronic catalog to others.

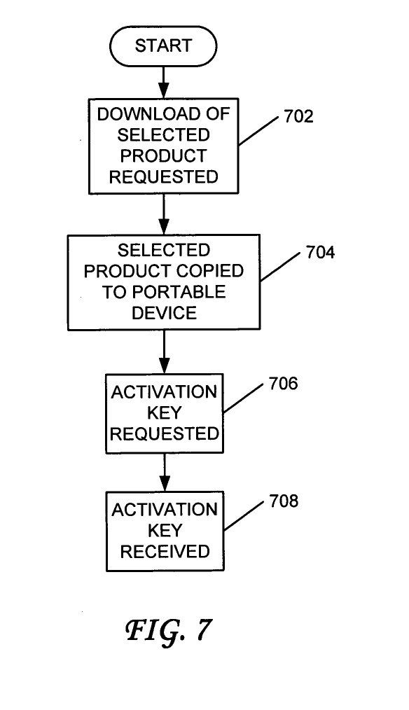

FIG. 7 illustrates a flowchart of an exemplary process, which may be performed in embodiments consistent with subject matter of this disclosure. The process may be performed on a portable processing device such as, for example, a handheld processing device with a display screen, or other processing device. The process may begin with the user selecting a product from an offline electronic catalog (act 702). The user may select a product by selecting a displayed node, thereby causing a list of products associated with the displayed node to be displayed on the display screen, and then selecting one of the products of the list of products. Of course, in other embodiments, other methods may be used for selecting a product from the offline electronic catalog. Assuming that the selected product is a digital product such as, for example, music, a video, an electronic game, a software application, or other digital product, the processing device may copy the selected product to a second portable device (act 704). The second portable device may be a second processing device and the copying may be performed via a wire connecting the portable devices or via a wireless means. In one implementation, the processing device may copy the selected product to the second portable device via an infrared connection. In another implementation, the processing device may copy the selected product to the second portable device via a radio frequency (RF) connection, a Bluetooth connection, or via other means. Alternatively, the processing device may copy a selected product to a portable storage device such as, for example, a U3 device, a flash RAM device, a CD, a DVD, or other portable storage device.

Some digital products may require an activation key to enable features of a digital product after installation. The user of the processing device having access to the offline electronic catalog may indicate a desire for an activation key via selection of a menu item, or via other means (act 706). The activation key may be sent via a network such as, for example, network 106, or via another network. In one implementation, a request for an activation key may be sent from the processing device to a processing device that includes the activation key by means of a Short Message Service (SMS) message. In other implementations, other means may be used to communicate the activation key request to the processing device that includes the activation key.

The processing device that includes the activation key may receive the activation key request and may respond by sending a message including the activation key via a network such as, for example, network 106 (act 708). In implementations in which the processing device receives the request for an activation key via a SMS message, the processing device may respond by sending a SMS including the activation key to the requesting processing device.

### Miscellaneous

Although the exemplary displays of FIGS. 3A-3D were described with respect to a display of a processing device communicating with an online database such as, for example, an online electronic catalog, the exemplary displays illustrate displays which may be implemented on a portable or other processing device accessing an offline database such as, for example, an offline electronic catalog. That is, a user of a processing device may view a group of nodes representing one or more products of an offline electronic catalog as illustrated in exemplary FIGS. 3A-3D. Further, a user of a portable processing device for viewing an offline electronic catalog may define a rule with respect to a derived attribute for determining whether a particular product described in the electronic catalog has the derived attribute. The rule may be defined in the same manner as described with respect to FIG. 5 using a rule editor executing on the portable processing device.

### CONCLUSION

Although the subject matter has been described in language specific to structural features and/or methodological acts, it is to be understood that the subject matter in the appended claims is not necessarily limited to the specific features or acts described above. Rather, the specific features and acts described above are disclosed as example forms for implementing the claims.

Although the above descriptions may contain specific details, they should not be construed as limiting the claims in any way. Other configurations of the described embodiments are part of the scope of this disclosure. Further, implementations consistent with the subject matter of this disclosure may have more or fewer acts than as described, or may implement acts in a different order than as shown. Accordingly, the appended claims and their legal equivalents should only define the invention, rather than any specific examples given.

We claim as our invention:

1. A method for providing graph and node-based categorization of products in an electronic catalog, the method comprising:
providing first information for a processing device to display, based on a content of an electronic catalog, a plurality of nodes, each of the plurality of nodes representing an attribute of one or more of the products in the electronic catalog;
receiving second information from the processing device indicating a selection of one of the plurality of nodes; and
providing third information for the processing device to pivot the plurality of nodes in response to the receiving of the second information, the third information for causing the processing device to display the selected one of the plurality of nodes as a root node and to display remaining ones of the plurality of nodes as descendants of the selected one of the plurality of nodes.

2. The method of claim 1, wherein each of the plurality of nodes represents an inherent attribute or a derived attribute of the one or more of the products in the electronic catalog.

3. The method of claim 1, further comprising:
receiving a fourth information from the processing device for pinning one of the remaining ones of the plurality of nodes;
providing fifth information for the processing device to add to the displayed pivoted plurality of nodes, in response to the receiving of the fourth information, at least one new node displayed as a descendent of the pinned one of the remaining ones of the plurality of nodes, each of the at least one displayed new node representing at least one product of the electronic catalog having attributes represented by the pinned one of the remaining ones of the plurality of nodes and a respective additional attribute.

4. The method of claim 1, further comprising:
providing fourth information for the processing device to display information with respect to at least one product associated with a selected node.

5. The method of claim 1, further comprising:
receiving fourth information from the processing device indicating a selection of at least a portion of the displayed plurality of nodes; and
downloading information with respect to the at least a portion of the displayed plurality of nodes to a portable device, thereby creating an offline electronic catalog of one or more products associated with the at least a portion of the selected displayed plurality of nodes.

6. The method of claim 1, further comprising:
receiving, from the processing device, fourth information;
defining a rule, based on the received fourth information, for determining whether a product has a particular derived attribute

7. The method of claim 1, wherein at least one of the attributes of the one or more of the products in the electronic catalog is a derived attribute determined according to a defined rule.

8. The method of claim 1, further comprising:
permitting the user to define a rule for determining whether a product has a particular derived attribute, the rule including at least one conditional statement for determining existence of a condition based on at least one attribute.

9. A processing device comprising:
at least one processor;
a memory including instructions for the at least one processor; and
a communication interface connecting the at least one processor with the memory,
wherein:
the instructions in the memory comprise:
instructions for providing information for displaying a plurality of nodes on a display device in response to receiving a request for access to an electronic catalog, each of the plurality of nodes representing an attribute of one or more products in an electronic catalog,
instructions for receiving selection information indicating a selection of one of the plurality of nodes displayed on the display device, and
instructions for providing pivoted display information, in response to the received selection information, for displaying the plurality of nodes on the display device in a pivoted configuration, the pivoted configuration including the selected one of the plurality of nodes in a root node position and remaining ones of the plurality of nodes in descendent node positions with respect to the selected one of the plurality of nodes.

10. The processing device of claim 9, wherein the instructions in the memory further comprise:
instructions for receiving a rule definition for defining whether a product of the one or more products in the electronic catalog has a derived attribute based on whether the product has one or more other attributes.

11. The processing device of claim 9, wherein the instructions in the memory further comprise:
instructions for receiving pinning information indicating a request to pin one of the remaining ones of the plurality of nodes, and
instructions for providing display information, in response to receiving the pinning information, for adding to the displayed pivoted configuration at least one new node displayed as a descendent to the pinned one of the remaining ones of the plurality of nodes, each of the at least one new node representing at least one product of the electronic catalog having an attribute represented by the pinned one of the remaining ones of the plurality of nodes and a respective additional attribute.

12. The processing device of claim 9, wherein the instructions in the memory further comprise:
instructions for receiving selection information indicating a selection of the at least a portion of the displayed plurality of nodes,
instructions for creating a catalog for offline use, the catalog including information related to one or more products associated with the selection of the at least a portion of the displayed plurality of nodes, and
instructions for downloading the catalog for offline use to a portable device.

13. The processing device of claim 9, wherein the instructions in the memory further comprise:
instructions for receiving selection information indicating a selection of the at least a portion of the displayed plurality of nodes,
instructions for creating a catalog for offline use, the catalog including information related to one or more products associated with the selection of the at least a portion of the displayed plurality of nodes, and
instructions for downloading the catalog for offline use to a portable device, wherein the catalog for offline use includes activation keys with respect to at least some of the one or more products included in the catalog for offline use.

14. The processing device of claim 9, wherein the instructions in the memory further comprise:
instructions for determining which ones of the one or more products in the electronic catalog have a derived attribute based on a rule, the rule indicating when the one or more products in the electronic catalog have the derived attribute based on particular values of other attributes of the one or more products in the electronic catalog.

15. A portable processing device comprising:
a display device;
at least one processor;
a memory including instructions for the at least one processor; and
a communication interface connecting the at least one processor, the memory, and the display device, wherein
the instructions in the memory comprise:
instructions for receiving an electronic catalog for offline use from a second processing device, the electronic catalog including a selected subset of an online electronic catalog, and
instructions for displaying, on the display device, information with respect to a plurality of products of the electronic catalog, wherein:
the electronic catalog includes digital content of at least some of the plurality of products.

16. The portable processing device of claim 15, wherein the instructions in the memory further comprise:
instructions for displaying, based on a content of the electronic catalog, a plurality of nodes, each of the plurality of nodes representing one or more of the products in the electronic catalog having a respective attribute;
instructions for permitting a pivot selection, by a user, of one of the plurality of displayed nodes; and
instructions for pivoting the displayed plurality of nodes in response to receiving the pivot selection of the one of the plurality of displayed nodes, such that the selected one of the plurality of nodes is displayed as a root node and remaining ones of the plurality of nodes are displayed as descendents of the selected one of the plurality of nodes.

17. The portable processing device of claim 15, wherein the instructions in the memory further comprise instructions for copying the digital content of at least some of the plurality of products of the electronic catalog to a portable storage medium.

18. The portable processing device of claim 15, wherein the instructions in the memory further comprise:
instructions for sending a first message requesting an activation key with respect to one of the plurality of products of the electronic catalog; and
instructions for receiving a second message including the activation key with respect to the one of the plurality of products of the electronic catalog.

19. The portable processing device of claim 15, wherein the instructions in the memory further comprise:
instructions for sending a first short message service message requesting an activation key with respect to one of the plurality of products of the electronic catalog; and
instructions for receiving a second short message service message including the activation key with respect to the one of the plurality of products of the electronic catalog.

20. The portable processing device of claim 15, wherein the instructions in the memory further comprise:
instructions for displaying, based on a content of the electronic catalog, a plurality of nodes, each of the plurality of nodes representing one or more of the products in the electronic catalog having a respective attribute;
instructions for permitting a pivot selection, by a user, of one of the plurality of displayed nodes;
instructions for pivoting the displayed plurality of nodes in response to receiving the pivot selection of the one of the plurality of displayed nodes, such that the selected one of the plurality of nodes is displayed as a root node and remaining ones of the plurality of nodes are displayed as descendents of the selected one of the plurality of nodes, wherein at least one of the respective attributes of the plurality of displayed nodes is a derived attribute determined according to a rule defined by a user.
